(19) United States
(12) Patent Application Publication
(10) Pub. No.: US 2007/0175359 A1
(43) Pub. Date: Aug. 2, 2007

(54) ELECTROLESS GOLD PLATING SOLUTION AND METHOD

(76) Inventor: Kilnam Hwang, Cranston, RI (US)

Correspondence Address: WINSTON & STRAWN LLP;PATENT DEPARTMENT, 1700 K STREET, N.W., WASHINGTON, DC, 20006, US

(21) Appl. No.: 11/566,935

(22) Filed: Dec. 5, 2006

Related U.S. Application Data
(60) Provisional application No. 60/764,575, filed on Feb. 1, 2006.

(51) Int. Cl. C23C 18/44; B05D 1/18; B05D 5/00

(52) U.S. Cl. 106/1.23; 106/1.26; 427/437; 427/443.1; 427/282

(57) ABSTRACT

Electroless gold plating compositions that include an adhesion enhancer compound and a reduction accelerator are provided to obtain direct electroless gold plating over a gold, nickel or nickel alloy deposit. A method of electroless gold plating on a nickel-containing substrate is also disclosed.

This application claims the benefit of application No. 60/764,575 filed Feb. 1, 2006, the entire content of which is expressly incorporated herein by reference thereto.

### BACKGROUND

The present invention relates to an electroless gold plating solution comprising certain mercaptosuccinic compounds and reduction accelerators for enhancing adhesion of a gold film to a substrate, an in particular one having an underlying nickel or nickel alloy deposit.

Generally, electroless gold plated coatings or layers have poor adhesion on nickel or nickel alloy underlayers. An immersion gold process, also referred to as galvanic displacement, provides strongly adhesive gold coatings on nickel or nickel alloys, but the thickness of the gold deposit is quite limited. The immersion gold reaction is driven by the thermodynamic potential couple between a gold and nickel-bearing substrate continues only until a uniform coating of gold is produced on the substrate surface at which time the process terminates.

Electroless gold processes are preferred over immersion gold processes because greater deposit thicknesses can be achieved. The electroless gold processes include a reducing agent as an electron donor to achieve such greater thicknesses by autocatalytic reaction (contributed by reducing agent) or combination of substrate catalytic and autocatalytic reaction. Thus, commercially acceptable electroless gold plating processes are intended to provide a high or indefinite deposit thickness depending on the reducing agent and the time an article is immersed in the electroless plating solution.

U.S. Pat. No. 5,232,492 discloses that the use of mixtures of sulfite and thiosulfate complexes provide a stable electroless plating solution when ethylenediaminetetraacetic acid disodium salt is used as an oxidation rate controller. The thiosulfate increases the stability of the initial gold sulfite complex by also forming gold thiosulfate complexes and functions as a source of sulfites. The gold thickness plated over an immersion gold deposit under conditions of pH 7.5 and 65° C. is 7 microinches after 15 minute.

U.S. Pat. No. 5,318,621 discloses electroless silver and gold plating solutions comprising a noncyanide metal complex, a thiosulfate, a sulfite, and water-soluble amino acids. The amino acid in this formulation provides an accelerated plating rate. The deposit rate is 1 to 1.5 μm/hour for silver and gold.

JP Pat. No. 2004-169058 discloses an electroless gold plating solution comprising a phenyl compound, benzotriazole, and a mercaptan compound as a stabilizer in the range of 1 to 50 ppm. The use of sulfite and thiosulfate as gold complexes are not mentioned in the application, but the bath may need these gold complexes to get a proper gold deposit. The gold plating rate obtained is about 0.7 to 0.85 μm/hour under the conditions of pH 7.4 and 65° C.

Most of the previous autocatalytic electroless gold plating solutions require an underlying immersion gold layer to obtain optimum adhesion of the electroless gold deposit onto a nickel or nickel alloy substrate. This adds cost and complexity to the process. In addition, many types of electroless gold plating solutions have previously been suggested which provide relatively non-hazardous bath chemistry, good deposit properties, and adequate plating rates, but the stability of these baths during actual production continues to be a problem and none of these baths is able to produce an electroless gold deposit directly over the underlying nickel deposit because of the poor adhesion of the electroless gold. Thus, improvements in this area are desired and necessary.

### SUMMARY OF THE INVENTION

The invention relates to an electroless gold plating solution comprising a solution-soluble gold compound, a sulfite compound in an amount sufficient to act as a complexing agent and reducing agent, a thiosulfate compound as a plating initiator, and a solution-soluble mercapto-based organic adhesion enhancer of the formula:

XOC(CH₂)ₙCHSHCOY

wherein X and Y independently are a hydroxyl, amine, or halide group or a monovalent cation and n is 1 to 5 in an amount sufficient to enhance adhesion of the electroless gold deposit to a substrate. The preferred adhesion enhancer is mercaptosuccinic acid or one of its solution-soluble salts.

The invention also relates to a method for electroless gold plating which comprises contacting a substrate to be plated with one of the electroless plating solutions defined herein for a time sufficient to provide an electroless gold deposit upon the portions of the substrate that are contacted by the solution. Preferably, the substrate is immersed in the solution and its entire outer surface is provided with an electroless gold deposit. The process is operable even when it is or includes a layer of nickel or a nickel alloy. If desired, the surface of the substrate to be plated can include a layer of immersion gold thereon prior to the electroless plating step. Also if desired, a substrate protecting organic material can be provided upon the substrate so that the gold plating is provided only upon selected portions of the substrate. Preferred substrate protecting organic materials include a benzotriazole, mercaptobezimidazole, or imidazole compound.

### BRIEF DESCRIPTION OF THE FIGURES

FIG. 1 is a graph showing the effect of temperature on gold plating rate in the electroless gold plating solution of Example 11;

FIG. 2 is a graph depicting plating thickness according to bath metal turnovers and plating rates; and

FIG. 3A is a scanning electron microscope image of the deposit obtained according to Example 11 after 1 metal turnover, while FIG. 3B is a scanning electron microscope image of the deposit obtained according to Example 11 after 5 metal turnovers.

### DETAILED DESCRIPTION OF THE PREFERRED EMBODIMENTS

The present invention relates to an electroless gold plating solution which has excellent adhesion on a nickel or nickel alloy layer with or preferably without an immersion gold deposit as an adhesion enhancement layer. The electroless gold plating solution of the present invention preferably includes a water-soluble gold compound, a sulfite as a complexing and reducing agent, a thiosulfate as a plating initiator, a hydroxy-bearing benzoic acid compound as a reduction accelerator and a mercapto-based organic adhesion enhancer compound.

Here, the thiosulfate compound plays a key role in initiating the plating of an electroless gold deposit. During the initial gold plating, the adsorbed species, (AU₂S₂O₃)_{ads}, forms on the nickel surface and then provides gold for the deposit by obtaining electrons from the sulfite.

The solution-soluble gold compound is typically present in an amount of 1 to 20 g/l, and is preferably is gold sulfite or gold thiosulfate. The preferred amount of solution-soluble gold ions are provided as a gold sulfite complex that is present in the range of about 1 to 10 g/l.

The sulfite compound is preferably an alkali metal sulfite, ammonium sulfite, or an alkyl sulfite and is typically present in an amount of 10 to 80 g/l. These compounds are used as a complexing and reducing agent and are preferably in the range of 20 to 80 g/l.

The thiosulfate compound is an alkali metal thiosulfate or ammonium thiosulfate and is typically present in an amount of 0.1 to 40 g/l. For optimum results, the sulfite and thiosulfate compounds are present in a weight ratio of from 50:1 to 1:2. Preferably, the sulfite and thiosulfate ions are present at a weight ratio of greater than 1:1 to 25:1.

The mercapto-based organic adhesion enhancer is mercaptosuccinate acid or one of its solution-soluble salts. This adhesion enhancer is typically present in an amount of about 0.1 to 30 g/l.

A benzoic acid compound having one to four hydroxyl group(s) or a solution-soluble salt thereof may be present in an amount sufficient to act as a reduction accelerator for gold plating from the solution. The preferred benzoic acid compounds include monohydroxybenzoic acid, dihydroxybenzoic acid or is a mono or di-hydroxy benzoate of an alkali metal or a halide. 2,4-dihydroxybenzoic acid, 2,5-dihydroxybenzoic acid, 3,4-dihydroxybenzoic acid, 3,5-dihydroxybenzoic acid, 2,3-dihydroxybenzoic acid, or 2,6-dihydroxybenzoic acid are the most preferred. These compounds are typically present in an amount of 1 to 40 g/l.

Additionally organic compounds having carboxylic and hydroxyl groups such as tartaric acid and its salts, lactic acid and its salt, gluconic acid and its salt may be useful in the present invention as grain refiners at about 1 to 40 g/l and preferably about 5 to 25 g/l. Any pH regulating compound which does not adversely affect the bath's gold plating capabilities may be used in these compositions. The preferred pH-regulating compound is a borate salt such as ammonium borate, triethanolamine or ammonium phosphate and the preferred amount is 1 to 10 g/l. The present compositions suitable for electroless gold plating are maintained at pH 5 to 9, preferably 5.5 to 7.5 owing to evolution of sulfur oxide when the pH is below 5. The electroless gold plating solution may also include a pH regulating compound in an amount sufficient to maintain the solution at a pH in the range of about 5 to 9.

The invention also relates to a method for electroless gold plating which comprises contacting a substrate article to be plated with one of the electroless gold plating solutions described herein for a time sufficient to provide an electroless gold deposit upon the portions of the substrate that are contacted by the solution wherein the deposit has increased adhesion to the substrate. The present electroless gold plating compositions comprising the adhesion enhancer along with a reduction accelerator provide excellent adhesion between the electroless gold deposit and the underlying nickel deposit with high bath stability. Also the disclosed compositions work when plated directly onto an immersion gold plated deposit on a metal substrate.

The substrate is generally immersed in the solution and its entire outer surface is provided with an electroless gold deposit. As noted, when the substrate includes a surface layer of nickel or a nickel alloy, the gold deposit is provided upon the surface layer with good adhesion. This is achieved whether the substrate comprises a nickel, a nickel boron alloy, or a nickel phosphorus alloy layer. Such layers are often utilized in electroplating of electronic components for various reasons. These layers can be provided on the substrate by electroless nickel or nickel alloy plating.

Although not mandatory, the nickel or nickel phosphorus layer may be provided with a coating of gold provided by an immersion gold plating process prior to providing the electroless gold plating thereon as this provides optimum adhesion for parts that are utilized in critical applications. The present invention also can produce a gold deposit on nickel or nickel alloys without this immersion gold plating step, as the present electroless gold solution provides an improvement in adhesion of the electroless gold deposit and an economical manufacturing process by eliminating the immersion gold plating process. Even gold or palladium substrates can be provided with an electroless gold deposit according to the present invention.

The balance of the solution is water. By formulating it as described herein, the resulting solution then can be free of alkali metal ions. Finally, if desired, the solution can further comprise conventional amounts of one or more of a polyamine and polyaminepolycarboxylic acid or one of their solution-soluble salts as a surfactant.

### EXAMPLES

The present invention will be described in detail in the following examples. These examples are intended to be illustrative of the invention and not to limit the invention. The electroless gold plating solution of the present invention can be applied for building up a gold deposit with excellent adhesion on a nickel or nickel alloy deposit which may be plated by an electroless or electrolytic plating method. All test pieces used in the present invention were copper clad printed circuit boards coated with a medium phosphorous nickel deposit or a thin immersion gold over a nickel or nickel alloy deposit.

A thick gold deposit with excellent adhesion and a practical plating speed is obtained in the present electroless gold solution containing a source of gold, a sulfite as a complexing and reducing agent and a thiosulfate as a plating initiator, benzoic acid components having dihydroxyl groups as a reduction accelerator, and a mercapto-based organic adhesion enhancer compound.

The thickness of the electroless gold deposit was measured by X-ray fluorescence and the deposit appearance was investigated by naked eyes and a stereomicroscope. Also, a tape test was carried out to measure adhesion between the gold and the underlying nickel deposit.

### Examples

Test articles having a size of 5.0 cm by 5.0 cm were prepared with the following sequence, rinsing 3 times with DI water after finishing each process step. They were treated with an acid cleaner, TechniClean AT-1000 (manufactured by Technic Inc.) at 50° C. for 3 minutes to remove oxides, fingerprints, and stains from the copper surface. Then the article was immersed in a microetch solution, TechniEtch AT-2000, at room temperature for 1 min. Further, the article was subject to an acid activation process, TechniActivator AT 3000, at room temperature for 30 seconds to provide adherent deposits to copper. Then the article was immersed in a palladium catalyst solution, TechniCatalyst AT-4000, at room temperature for one minute to support the uniform initiation of nickel reduction on the copper surface. Subsequently, the article was plated with an electroless nickel process, TechniENickel AT-5000, at 90° C. for 15 minutes to produce an electroless nickel deposit having 7˜10% P content. In example 10 below, the article was immersed in an immersion gold solution, Techni Oromerse SO, at 80° C. for 8 minutes.

### Example 1

An electroless gold plating solution was prepared and carried out by combining the

| | |
|---|---|
| Gold as Ammonium Gold Sulfite | 3.4 g/l |
| Ammonium Sulfite | 35 g/l |
| Ammonium Thiosulfate | 15 g/l |
| Mercaptosuccinic acid | 0.9 g/l |
| pH | 7.1 |
| Temperature | 70° C. |

Gold deposits were produced from the above solution and operating conditions by electroless plating onto an electroless nickel deposit. The thickness obtained was 31.6 microinches after 1 hour. The gold deposits had a uniform and yellow appearance and did not peel off in a tape test. The bath showed no plate out or other instability.

### Example 2

### Comparative

An electroless gold plating solution was prepared and carried out by combining the following:

| | |
|---|---|
| Gold as Ammonium Gold Sulfite | 3.4 g/l |
| Ammonium Sulfite | 35 g/l |
| Ammonium Thiosulfate | 15 g/l |
| pH | 7.3 |
| Temperature | 70° C. |

Gold deposits were produced from the above solution and operating conditions by electroless plating onto an electroless nickel deposit. The thickness obtained was 71.7 microinches after 1 hour. The gold deposits had an uneven and yellow appearance and peeled off in a tape test. The bath showed no plate out or other instability.

### Example 3

An electroless gold plating solution was prepared and carried out by combining the following:

| | |
|---|---|
| Gold as Ammonium Gold Sulfite | 3.4 g/l |
| Ammonium Sulfite | 42 g/l |
| Ammonium Thiosulfate | 15 g/l |
| 3,5-Dihydroxybenzoic acid | 20 g// |
| Mercaptosuccinic acid | 0.9 g/l |
| pH | 6.6 |
| Temperature | 70° C. |

Gold deposits were produced from the above solution and operating conditions by electroless plating onto an electroless nickel deposit. The thickness obtained was 48.8 microinches after 1 hour. The gold deposits had a uniform and deep yellow appearance and did not peel off in a tape test. The bath showed no plate out or other instability.

### Example 4

An electroless gold plating solution was prepared and carried out by combining the following:

| | |
|---|---|
| Gold as Ammonium Gold Sulfite | 3.4 g/l |
| Ammonium Sulfite | 60 g/l |
| Ammonium Thiosulfate | 15 g/l |
| 3,5-Dihydroxybenzoic acid | 20 g// |
| Mercaptosuccinic acid | 2 g/l |
| pH | 7.0 |
| Temperature | 70° C. |

Gold deposits were produced from the above solution and operating conditions by electroless plating onto an electroless nickel deposit. The thickness obtained was 32.5 microinches after 1 hour. The gold deposits had a uniform and deep yellow appearance and did not peel off in a tape test. The bath showed no plate out or other instability.

### Example 5

### Comparative

An electroless gold plating solution was prepared and carried out by combining the following:

| | |
|---|---|
| Gold as Ammonium Gold Sulfite | 3.4 g/l |
| Ammonium Sulfite | 45 g/l |
| Ammonium Thiosulfate | 15 g/l |
| 3,5-Dihydroxybenzoic acid | 20 g// |
| pH | 6.6 |
| Temperature | 70° C. |

Gold deposits were produced from the above solution and operating conditions by electroless plating onto an electroless nickel deposit. The thickness obtained was 79.8 microinches after 1 hour. The gold deposits had a slight uneven and deep yellow appearance and peeled off in a tape test. The bath showed no plate out or other instability.

### Example 6

### Comparative

An electroless gold plating solution was prepared and carried out by combining the following:

| | |
|---|---|
| Gold as Sodium Gold Sulfite | 3.4 g/l |
| Sodium Sulfite | 42 g/l |
| Sodium Thiosulfate | 15 g/l |
| 2,4-Dihydroxybenzoic acid | 20 g// |
| Tetrasodium Borate | 4 g/l |
| pH | 6.7 |
| Temperature | 70° C. |

Gold deposits were produced from the above solution and operating conditions by electroless plating onto an electroless nickel deposit. The thickness obtained was 69.1 microinches after 1 hour. The gold deposits had a little uneven and yellow appearance and peeled off in a tape test. The bath showed no plate out or other instability.

### Example 7

An electroless gold plating solution was prepared and carried out by combining the following:

| | |
|---|---|
| Gold as Ammonium Gold Sulfite | 3.4 g/l |
| Ammonium Sulfite | 42 g/l |
| Ammonium Thiosulfate | 15 g/l |
| 3,5-Dihydroxybenzoic acid | 20 g// |
| Ammonium Tartrate Dibasic | 10 g/l |
| Mercaptosuccinic acid | 0.9 g/l |
| Ammonium Biborate | 4 g/l |
| pH | 6.8 |
| Temperature | 70° C. |

Gold deposits were produced from the above solution and operating conditions by electroless plating onto an electroless nickel deposit. The thickness obtained was 54.9 microinches after 1 hour. The gold deposits had a uniform and deep yellow appearance and did not peel off in a tape test. The bath showed no plate out or other instability.

### Example 8

An electroless gold plating solution was prepared and carried out by combining the following:

| | |
|---|---|
| Gold as Sodium Gold Sulfite | 3.4 g/l |
| Sodium Sulfite | 37 g/l |
| Sodium Thiosulfate | 25 g/l |
| 3,5-Dihydroxybenzoic acid | 20 g// |
| Tartaric acid | 10 g/l |
| Mercaptosuccinic acid | 0.9 g/l |
| Tetrasodium Borate | 4 g/l |
| pH | 7.0 |
| Temperature | 70° C. |

Gold deposits were produced from the above solution and operating conditions by electroless plating onto an electroless nickel deposit. The thickness obtained was 58.7 microinches after 1 hour. The gold deposits had a uniform and deep yellow appearance and did not peel off in a tape test. The bath showed no plate out or other instability.

### Example 9

An electroless gold plating solution was prepared and carried out by combining the following:

| | | |
|---|---|---|
| Gold as Ammonium Gold Sulfite | 3.4 | g/l |
| Ammonium Sulfite | 42 | g/l |
| Ammonium Thiosulfate | 7 | g/l |
| 3,5-Dihydroxybenzoic acid | 20 | g// |
| Ammonium Tartrate Dibasic | 10 | g/l |
| Mercaptosuccinic acid | 0.9 | g/l |
| Ammonium Biborate | 4 | g/l |

| | |
|---|---|
| PH | 6.8 |
| Temperature | 70° C. |

Gold deposits were produced from the above solution and operating conditions by electroless plating onto an electroless nickel deposit. The thickness obtained was 42.7 microinches after 1 hour. The gold deposits had a uniform and deep yellow appearance and did not peel off in a tape test. The bath showed no plate out or other instability.

### Example 10

An electroless gold plating solution was prepared and carried out by combining the following:

| | |
|---|---|
| Gold as Ammonium Gold Sulfite | 3.4 g/l |
| Ammonium Sulfite | 42 g/l |
| Ammonium Thiosulfate | 15 g/l |
| 3,5-Dihydroxybenzoic acid | 20 g// |
| Ammonium Tartrate Dibasic | 10 g/l |
| Mercaptosuccinic acid | 0.9 g/l |
| Ammonium Biborate | 4 g/l |
| PH | 6.8 |
| Temperature | 70° C. |

Gold deposits were produced from the above solution and operating conditions by electroless plating onto an immersion gold plated on an electroless nickel deposit. The thickness obtained was 31.3 microinches after 1 hour. The gold deposits had a uniform and deep yellow appearance and did not peel off in a tape test. The bath showed no plate out or other instability.

An acceptable bondability was obtained, as shown in Table 1, with all samples plated in the present electroless gold plating solution under variable conditions of pretreatment and with nickel underlayers that were plated with either an electroless or electrolytic method. Bondability was determined as follows:
Bonding method and equipment: Thermosonic gold wire ball bonding with 0.001″ Au wire (AW28) and K&S 1488 turbo.
Substrate pretreatment: Sample 1 and 3 was pre-cleaned in 10% sulfuric acid instead of TechniClean AT-1000 that is one of processes in this invention.
Sample preparation
Samples 1 and 2: Electroless gold deposit (1 μm)/Electrolytic nickel deposit (2 μm)/Copper circuit patterns.

Samples 3 and 4: Electroless gold deposit (1 μm)/Electroless nickel deposit (2 μm)/Copper circuit patterns.

TABLE 1
Wire bondability test results of the electroless gold deposit plated in
example 10 with a flexible circuit substrate.

| Location | Sample 1 | Sample 2 | Sample 3 | Sample 4 |
|---|---|---|---|---|
| #1 | 3.96 | 4.38 | 9.76 | 9.94 |
| #2 | 5.80 | 6.62 | 7.98 | 5.42 |
| #3 | 8.52 | 8.10 | 6.90 | 6.58 |
| #4 | 5.40 | 7.76 | 9.08 | 6.36 |
| #5 | 9.98 | 11.38 | 7.0 | 6.64 |
| #6 | 6.30 | 8.98 | 9.04 | 7.60 |
| #7 | 7.30 | 10.20 | 7.34 | 9.22 |
| #8 | 6.12 | 6.44 | 6.98 | 8.80 |
| #9 | 5.44 | 7.39 | 5.78 | 6.48 |
| Average | 6.54 | 7.92 | 7.76 | 7.45 |

### Example 11

An electroless gold plating solution was prepared and carried out by combining the following:

| | | |
|---|---|---|
| Gold as Ammonium Gold Sulfite | 3.4 | g/l |
| Ammonium Sulfite | 42 | g/l |
| Ammonium Thiosulfate | 38 | g/l |
| 3,5-Dihydroxybenzoic acid | 16 | g// |
| Ammonium Tartrate Dibasic | 10 | g/l |
| Mercaptosuccinic acid | 2 | g/l |
| Ammonium Biborate | 3 | g/l |
| Ethylenediamine | 0.2 | g/l |

| | |
|---|---|
| pH | 6.6 |
| Temperature | 70° C. |

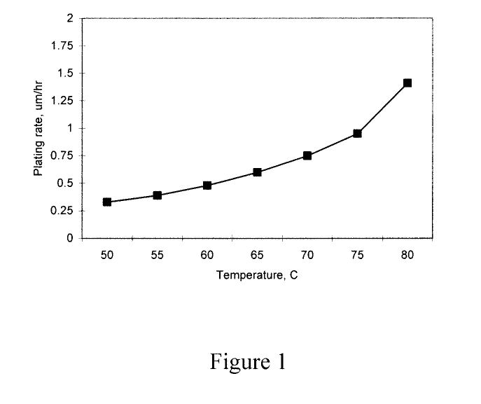

Gold deposits were produced from the above solution and operating conditions by electroless plating onto an immersion Au plated on an electroless nickel deposit. The thickness obtained was exponentially increased with increasing temperature shown in FIG. 1. The gold deposits had a uniform and deep yellow appearance and did not peel off in a tape test. The bath showed no plate out or other instability.

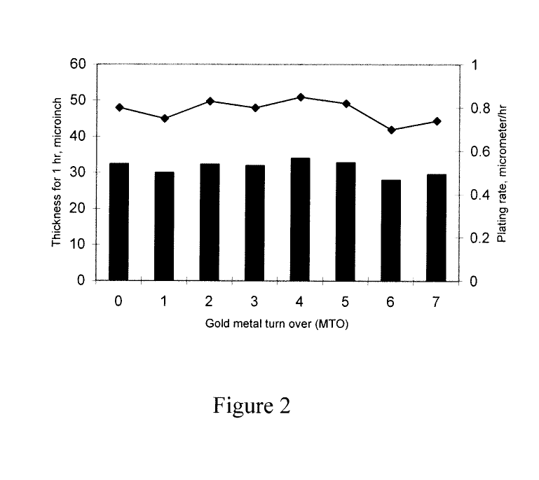

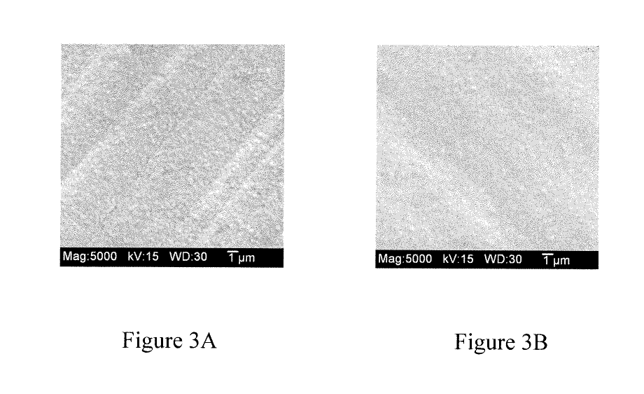

The bath life under controlled conditions to over 5 metal turnovers (MTO), as shown in the FIG. 2, was obtained without any plate out or other instability. The gold plating rate was not significantly decreased with elapsing MTOs, but precipitates appeared during gold plating without solution decomposition after 6 MTOs. The electroless gold deposit plated at 1 MTO and 5 MTOs have good appearance having homogeneous grains shown in the FIGS. 3A and 3B. These scanning electron microscope images were taken at 5000× magnification from the electroless gold deposit plated from the aged solutions.

The present disclosure uses gold as an example of a preferred metal to be electrolessly deposited, but the teachings of this invention are also applicable to other metals, such as silver or palladium, for example. The skilled artisan will realize that the solution may need minor modifications to find the optimum solution soluble compounds of those metals but the other bath additives should be essentially the same as those disclosed herein.

What is claimed is:

1. An electroless gold plating solution comprising a solution-soluble gold compound, a sulfite compound in an amount sufficient to act as a complexing agent and reducing agent, a thiosulfate compound as a plating initiator, and a solution-soluble mercapto-based organic adhesion enhancer of the formula:
XOC(CH₂)ₙCHSHCOY
wherein X and Y independently are a hydroxyl, amine, or halide group or a monovalent cation and n is 1 to 5 in an amount sufficient to enhance adhesion of the electroless gold deposit to a substrate.

2. The electroless gold plating solution of claim 1, wherein the solution-soluble gold compound is present in an amount of 1 to 20 g/l.

3. The electroless gold plating solution of claim 2, wherein the solution-soluble gold compound is gold sulfite or gold thiosulfate.

4. The electroless gold plating solution of claim 1, wherein the sulfite compound is an alkali metal sulfite, ammonium sulfite, or an alkyl sulfite.

5. The electroless gold plating solution of claim 4, wherein the sulfite compound is present in an amount of 10 to 80 g/l.

6. The electroless gold plating solution of claim 1, wherein the thiosulfate compound is an alkali metal thiosulfate or ammonium thiosulfate.

7. The electroless gold plating solution of claim 6, wherein the thiosulfate compound is present in an amount of 0.1 to 40 g/l.

8. The electroless gold plating solution of claim 1, wherein the sulfite and thiosulfate compounds are present in a weight ratio of from 50:1 to 1:2.

9. The electroless gold plating solution of claim 1, wherein the mercapto-based organic adhesion enhancer is mercaptosuccinate acid or one of its solution-soluble salts.

10. The electroless gold plating solution of claim 1, wherein the mercapto-based organic adhesion enhancer is present in an amount of about 0.1 to 30 g/l.

11. The electroless gold plating solution of claim 1, further comprising an organic grain refiner compound having hydroxyl and carboxyl groups.

12. The electroless gold plating solution of claim 9, wherein the grain refiner compound is tartaric acid, lactic acid, gluconic acid or one of their solution-soluble salts and is present in an amount of about 0.1 to 40 g/l.

13. The electroless gold plating solution of claim 1, which further comprises a benzoic acid compound having one to four hydroxyl group(s) or a solution-soluble salt thereof in an amount sufficient to act as a reduction accelerator for gold plating from the solution.

14. The electroless gold plating solution of claim 13, wherein the benzoic acid compound is monohydroxybenzoic acid, dihydroxybenzoic acid or is a mono or di-hydroxy benzoate of an alkali metal or a halide.

15. The electroless gold plating solution of claim 13, wherein the benzoic acid compounds are 2,4-dihydroxybenzoic acid, 2,5-dihydroxybenzoic acid, 3,4-dihydroxybenzoic acid, 3,5-dihydroxybenzoic acid, 2,3-dihydroxybenzoic acid, or 2,6-dihydroxybenzoic acid.

16. The electroless gold plating solution of claim 13, wherein the benzoic acid compound is present in an amount of 1 to 40 g/l.

17. The electroless gold plating solution of claim 1, further comprising a pH regulating compound in an amount sufficient to maintain the solution at a pH in the range of about 5 to 9.

18. The electroless gold plating solution of claim 17, wherein the pH regulating compound is ammonium borate, triethanolamine, or ammonium phosphate and the pH is maintained in the range of about 5.5 to 7.5.

19. The electroless gold plating solution of claim 1, which further comprises one or more of a polyamine and polyaminepolycarboxylic acid or one of their solution-soluble salts as a surfactant.

20. A method for electroless gold plating which comprises contacting a substrate article to be plated with the electroless gold plating solution of claim 1 for a time sufficient to provide an electroless gold deposit upon the portions of the substrate that are contacted by the solution wherein the deposit has increased adhesion to the substrate.

21. The method of claim 20, wherein the substrate is immersed in the solution and its entire outer surface is provided with an electroless gold deposit.

22. The method of claim 20, wherein the substrate includes a surface layer of nickel or a nickel alloy and the gold deposit is provided upon the surface layer.

23. The method of claim 22, wherein the substrate comprises nickel, a nickel boron alloy, or a nickel phosphorus alloy that is provided on the substrate by electroless nickel or nickel alloy plating.

24. The method of claim 23, wherein the nickel or nickel phosphorus deposit is provided with a coating of gold provided by an immersion gold plating process prior to providing the electroless gold plating thereon.

25. The method of claim 20, which further comprises providing a substrate protecting organic material upon the substrate so that the gold plating is provided only upon selected portions of the substrate.

26. The method of claim 25 wherein the substrate protecting organic material is a benzotriazole, mercaptobezimidazole, or imidazole compound.
